(19) United States
(12) Patent Application Publication
(10) Pub. No.: US 2026/0030793 A1
(43) Pub. Date: Jan. 29, 2026

(54) DYNAMIC ATTENTIONAL REGION GENERATION AND RENDERING

(71) Applicant: Samsung Electronics Co., Ltd., Suwon-si (KR)

(72) Inventors: Yingen Xiong, Mountain View, CA (US); Christopher A. Peri, Mountain View, CA (US)

(21) Appl. No.: 19/268,630

(22) Filed: Jul. 14, 2025

Related U.S. Application Data
(60) Provisional application No. 63/675,184, filed on Jul. 24, 2024.

(51) Int. Cl. G06T 11/00; G06F 3/01; G06T 5/20; G06T 5/50; G06T 5/70; G06T 5/73; G06V 40/19

(52) U.S. Cl. CPC G06T 11/00; G06F 3/013; G06T 5/20; G06T 5/50; G06T 5/70; G06T 5/73; G06V 40/19; G06T 2207/20012; G06T 2207/20192

(57) ABSTRACT

A method includes obtaining one or more image frames of a scene and data associated with the one or more image frames where the data includes user eye behavior data. The method also includes applying passthrough transformations on the one or more image frames to generate one or more transformed image frames. The method further includes identifying an attentional region in the one or more transformed image frames based on the user eye behavior data. The method also includes adjusting lightness of the one of more transformed image frames using a weighting distribution to generate one or more modified image frames where the lightness is attenuated from a center point of the attentional region towards edges of the one or more transformed image frames. In addition, the method includes rendering one or more images for display based on the one or more modified image frames.

### CROSS-REFERENCE TO RELATED APPLICATION AND PRIORITY CLAIM

This application claims priority under 35 U.S.C. § 119 (e) to U.S. Provisional Patent Application No. 63/675,184 filed on Jul. 24, 2024, which is hereby incorporated by reference in its entirety.

### TECHNICAL FIELD

This disclosure relates generally to image processing systems and processes. More specifically, this disclosure relates to dynamic attentional region generation and rendering.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to dynamic attentional region generation and rendering.

In a first embodiment, a method includes obtaining, using a plurality of sensors of an electronic device, one or more image frames of a scene and data associated with the one or more image frames where the data includes user eye behavior data. The method also includes applying, using at least one processing device of the electronic device, passthrough transformations on the one or more image frames to generate one or more transformed image frames. The method further includes identifying, using the at least one processing device, an attentional region in the one or more transformed image frames based on the user eye behavior data. The method also includes adjusting, using the at least one processing device, lightness of the one of more transformed image frames using a weighting distribution to generate one or more modified image frames where the lightness is attenuated from a center point of the attentional region towards edges of the one or more transformed image frames. In addition, the method includes rendering, using the at least one processing device, one or more images for display based on the one or more modified image frames.

In a second embodiment, an apparatus includes a plurality of sensors configured to obtain one or more image frames of a scene and data associated with the one or more image frames, where the data includes user eye behavior data. The apparatus also includes at least one processing device configured to apply passthrough transformations on the one or more image frames to generate one or more transformed image frames and identify an attentional region in the one or more transformed image frames based on the user eye behavior data. The at least one processing device is also configured to adjust lightness of the one of more transformed image frames using a weighting distribution to generate one or more modified image frames, where the lightness is attenuated from a center point of the attentional region towards edges of the one or more transformed image frames. The at least one processing device is further configured to render one or more images for display based on the one or more modified image frames.

In a third embodiment, a non-transitory machine readable medium contains instructions that when executed cause at least one processor of an electronic device to obtain one or more image frames of a scene and data associated with the one or more image frames, where the data includes user eye behavior data. The non-transitory machine readable medium also contains instructions that when executed cause the at least one processor to apply passthrough transformations on the one or more image frames to generate one or more transformed image frames and identify an attentional region in the one or more transformed image frames based on the user eye behavior data. The non-transitory machine readable medium further contains instructions that when executed cause the at least one processor to adjust lightness of the one of more transformed image frames using a weighting distribution to generate one or more modified image frames, where the lightness is attenuated from a center point of the attentional region towards edges of the one or more transformed image frames. In addition, the non-transitory machine readable medium contains instructions that when executed cause the at least one processor to render one or more images for display based on the one or more modified image frames.

Any one or any combination of the following features may be used with the first, second, or third embodiment. The attentional region may be identified by identifying an element of a user focus in the one or more transformed image frames (where the element may include an object, an image portion, or an area of the user focus); identifying a focus point and a corresponding focal distance based on the element; creating an attentional mask using the focus point and the corresponding focal distance (where the attentional mask may encompass the element); and generating the attentional region using the attentional mask (where the attentional region may include the element). A de-attentional region disposed outside of a boundary of the attentional region may be identified. The lightness of the one or more transformed image frames may be adjusted by converting a color format of the one or more transformed image frames to extract lightness data; creating the weighting distribution using the attentional mask; and applying the weighting distribution to the attentional region and the de-attentional region to adjust the lightness. The lightness at the center point of the attentional region may be unchanged and attenuated towards edges of the de-attentional region such that the de-attentional region has little or no lightness at the edges. The attentional mask may have a shape including one of a rectangle, a circle, or an ellipse based on the element of the user focus and the focal distance. The lightness of the one or more transformed image frames may be adjusted by applying an attentional lightness transformation on the attentional region using a distribution algorithm for the weighting distribution and applying a de-attentional lightness transformation on a de-attentional region disposed outside of a boundary of the attentional region using the distribution algorithm. The weighting distribution includes a Gaussian distribution or a cosine distribution. The weighting distribution may be dynamically adaptive to a user focus. Visual enhancement on the attentional region may be applied, and the visual enhancement may include noise reduction and image enhancement.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example process for dynamic attentional region generation and rendering in accordance with this disclosure;

FIG. 3 illustrates another example process for dynamic attentional region generation and rendering in accordance with this disclosure;

FIGS. 4A-4C illustrate example functions in the process of FIG. 3 in accordance with this disclosure;

FIGS. 5A-5D illustrate example attentional masks created in accordance with this disclosure;

FIGS. 6A-6C illustrate an example technique for adaptive lightness transformation in accordance with this disclosure;

FIGS. 7A-7B illustrate example weighting distributions of lightness adjustments in accordance with this disclosure;

FIGS. 8A-8B illustrate example results obtainable using dynamic attentional region generation and rendering in accordance with this disclosure; and

FIG. 9 illustrates an example method for dynamic attentional region generation and rendering in accordance with this disclosure.

### DETAILED DESCRIPTION

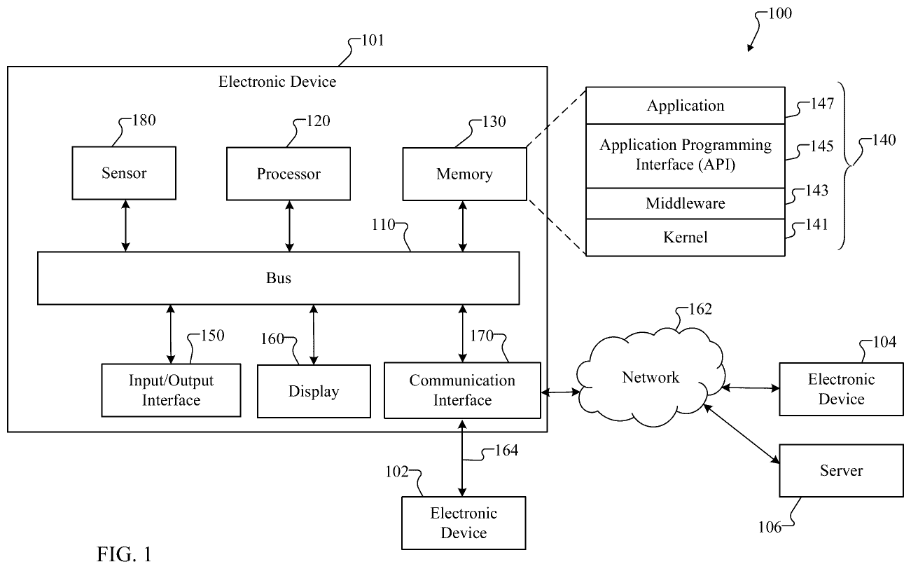

FIGS. 1 through 9, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video see-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “see-through cameras”) that capture high-resolution image frames of a user's surrounding environment. These image frames are processed in an image processing pipeline in order to generate final rendered views of the user's surrounding environment. Unfortunately, VST XR devices can suffer from various problems. For example, in human vision, binocular or stereoscopic vision is about 120°, and a person's focus vision is about 30° in the central area of the stereoscopic vision. In other words, the foveal field of view (FOV) is about 30° in the central area, and the binocular vision FOV is about 120° (including foveal and peripheral areas). In VST XR, however, the user accesses his or her surroundings through see-through cameras installed on a VST XR device (such as a VST XR headset). The VST XR device captures the surrounding scene and renders it to one or more displays. The user can view images on the display(s) through display lenses to view the captured scene, including the user's focus region and the surrounding regions. However, the user may be interested primarily in the details about the user's focus region, not the surrounding regions.

This disclosure provides various techniques for dynamic attentional region generation and rendering in XR or other applications. As described in more detail below, the described techniques dynamically create an attentional region corresponding to a user's focus area. By separating an image frame into an attentional region and a de-attentional region, tailored processing of a captured scene corresponding to a user's focus and interest may be performed. That is, the attentional region corresponding to the user's focus region can be accurately processed, while less processing efforts can be used with the de-attentional region.

In this way, the disclosed techniques can be used to provide high-quality attentional regions on which the user can easily focus, thereby enhancing the user's experience, while reducing the amount of overall processing by performing less processing of the de-attentional region. For example, the disclosed techniques can be used to create adaptive weighting distributions to adjust the lightness of the attentional region to fit the human vision to focus on any objects and scene in the attentional region. Further, the lightness becomes darker towards the edges of the de-attentional region so as to allow natural and better viewing of the focus region.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to dynamic attentional region generation and rendering in XR or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform dynamic attentional region generation and rendering. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include one or more cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to dynamic attentional region generation and rendering in XR or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

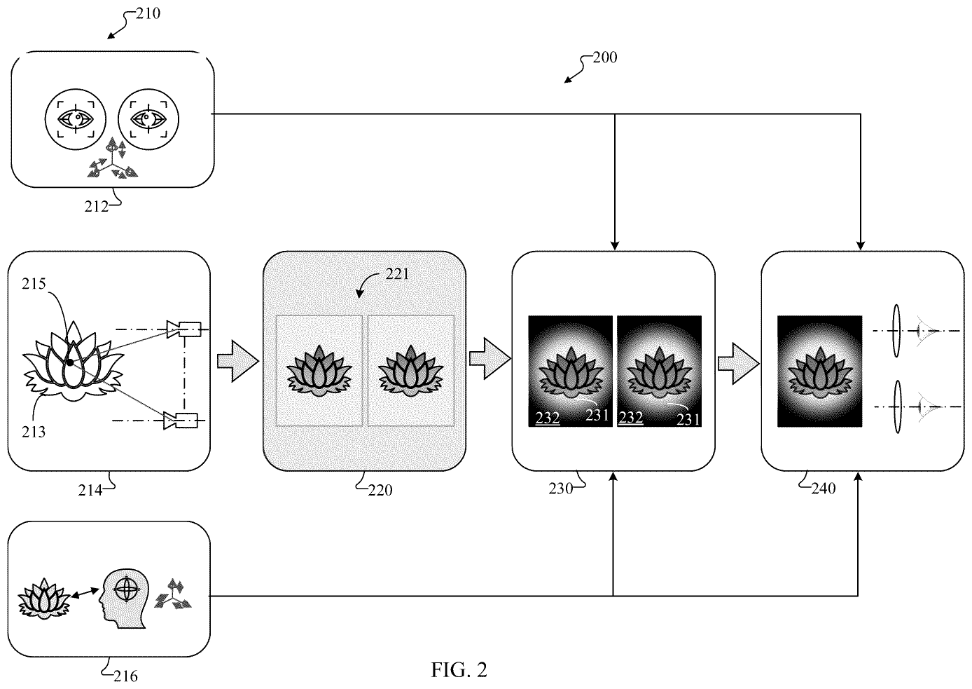

FIG. 2 illustrates an example process 200 for dynamic attentional region generation and rendering in accordance with this disclosure. For case of explanation, the process 200 shown in FIG. 2 is described as being performed using the electronic device 101 in the network configuration 100 shown in FIG. 1. However, the process 200 shown in FIG. 2 may be performed using any other suitable device(s) and in any other suitable system(s).

As shown in FIG. 2, the process 200 includes a data capture operation 210, a passthrough transformation operation 220, an attentional region generation and lightness adjustment operation 230, and a frame rendering operation 240. The data capture operation 210 generally operates to capture a color frame image and associated data. In this example, the data capture operation 210 includes an eye behavior data capture operation 212, an image frame capture operation 214, and a head pose data capture operation 216. In some examples, the data capture operation 210 also includes a depth data capture operation.

The eye behavior data capture operation 212 generally operates to capture the user's eye behavior data. This may include one or more imaging sensors 180 capturing one or more images of the user's eyes and the processor 120 identifying the focus point and focal distance based on the captured eye images. For example, the user may focus on a 3D focus point or object in a scene while wearing the electronic device 101. The user's eye movements can be obtained by tracking and capturing images of the user's eyes and estimating the eye gaze direction and depth to obtain the focus point and focal distance. For instance, an illuminator can emit infrared light to the user's eyes, and one or more imaging sensors 180 can capture images of pupil and corneal reflections. The processor 120 can identify the center of the user's pupils in the captured images of the user's eyes and estimate the direction and depth of the user's eye gaze to determine a focus point and focal distance between the user's eyes and the focus point.

The image frame capture operation 214 generally operates to capture one or more image frames of a scene. This may include the processor 120 obtaining the one or more image frames and depth data of the surroundings in the scene. In some cases, each image frame may be a high-resolution color image frame, such as one captured by the electronic device 101 using one or more imaging sensors 180 of the electronic device 101. Also, in some cases, each captured image frame may represent an image frame of a scene captured by a forward-facing camera or other imaging sensor(s) 180 of the electronic device 101. The one or more captured image frames can undergo one or more passthrough transformations as described below.

The head pose data capture operation 216 generally operates to obtain information related to the pose of a user's head while the electronic device 101 is being used. The head pose information may be obtained from any suitable source(s), such as from one or more positional sensors like at least one IMU, head pose tracking camera, or other position sensor(s) 180 of the electronic device 101. In some cases, the head pose information may be expressed using six degrees of freedom, such as three translation values and three rotation values. The three translation values may identify the movement of the user's head along three orthogonal axes, and the three rotation values may identify rotation of the user's head about the three orthogonal axes. Note, however, that the head pose information may have any other suitable form.

The passthrough transformation operation 220 generally operates to apply one or more transformations to the one or more image frames in order to generate one or more transformed image frames 221. This may include the processor 120 applying one or more transformations to compensate for things like registration and parallax errors, which may be caused by factors like differences between the positions of the imaging sensor(s) 180 and a user's eyes. That is, captured image frames are captured by one or more imaging sensor(s) 180 at one or more locations, but rendered images are viewed by a user's eyes that are at different locations. The passthrough transformation operation 220 can apply one or more transformations in order to compensate for these differences in viewpoints. In some cases, the passthrough transformation operation 220 may apply a rotation and/or a translation to each image frame in order to compensate for these or other types of issues. Ideally, the transformations give the appearance that the images presented to the user are captured at the locations of the user's eyes, when the image frames in reality are captured at one or more different locations. Often times, the rotation and/or translation can be derived mathematically based on the position and angle of each imaging sensor 180 and the expected or actual positions of the user's eyes. In some cases, the transformations are static (since these positions and angles will not change), allowing passthrough transformations to be applied quickly.

The attentional region generation and lightness adjustment operation 230 generally operates to identify an attentional region (a focus region) in the one or more transformed image frames 221. This may include the processor 120 creating an attentional mask using a focus point 215 and a focal distance (a distance between the focus point 215 and a midpoint of the interpupillary distance), generating an attentional region 231 using the attentional mask, creating a weighting distribution of lightness adjustments in the one or more transformed image frames 221, and applying the weighting distribution to adjust the lightness in the one or more transformed image frames 221 by performing a light transformation.

To create an attentional mask, the processor 120 may obtain the focus point 215 and the focal distance from the eye behavior information and determine the size, shape, and boundary of the attentional mask using the focus point 215 and the focal distance. Attentional masks can have various shapes and sizes. For example, if the user is focusing on a semi-truck, the processor 120 may generate an attentional mask having a size and shape (such as rectangular) sufficient to encompass the semi-truck. If the user is focusing on a ball, the processor 120 may generate a mask having a size and shape (such as circular) appropriate to encompass the ball.

The processor 120 can generate an attentional region 231 using the attentional mask. For example, the attentional region 231 may have the same size, shape, and boundary as the attentional mask. The attentional region 231 represents the focus region (including the object 213) of user focus. A peripheral region disposed outside of the boundary of the attentional region 231 is referred to as a de-attentional region 232.

In some cases, the processor 120 may create a weighting distribution for adjusting lightness in the attentional region 231 using the attentional mask. The weighting distribution may also be applied to the de-attentional region 232. The weighting distribution may be any type of distribution algorithm (such as a Gaussian distribution or cosine distribution) as appropriate without departing from the scope of this disclosure. Different weighting distributions can be created for different attentional regions.

The processor 120 may apply the weighting distribution to the one or more transformed image frames 221 to perform lightness transformation. For example, the processor 120 may apply a kernel of lightness transformation (the weighting distribution) in the attentional region 231 to perform an attentional lightness transformation with the lightness peaking at the center of the attentional region 231 and gradually attenuating towards the boundary of the attentional region 231. For the de-attentional region 232, the processor 120 may apply the weighting distribution to perform a de-attentional lightness transformation such that the de-attentional region 232 has little or no lightness. For example, the lightness may gradually feather out from the boundary of the attentional region 231 towards the edges of the de-attentional region 232. That is, the de-attentional region 232 can have a low lightness and eventually become dark toward a frame boundary of the one or more transformed image frames 221. In some cases, the processor 120 may adjust lightness in the attentional region 231 after the attentional lightness transformation has been performed.

By separating the attentional region 231 from the de-attentional region 232 and adjusting the lightness to highlight the attentional region 231, the attentional region generation and lightness adjustment operation 230 allows the user to focus with case on the region of his or her interest and ignore any regions of little or no interest. Also, by adjusting the lightness across the boundary of the attentional region 231 with a fade-like effect, the attentional region generation and lightness adjustment operation 230 can help to ensure a smooth transition of the lightness from the attentional region 231 to the de-attentional region 232, thereby reducing or minimizing user discomfort. In addition, as the user's focus shifts in the same scene or to a different scene, the attentional region generation and lightness adjustment operation 230 can dynamically adapt to the user's instantaneous focus point and focal distance, generating and adjusting lightness in new attentional and de-attentional regions so as to provide continuous user enjoyment without discomfort.

The frame rendering operation 240 generally operates to create one or more final image frames of the converted transformed image frames including the processed attentional region and de-attentional region. The frame rendering operation 240 can also render the final views for presentation to a user of the electronic device 101. For example, the frame rendering operation 240 may process the converted image frames and perform any additional refinements or modifications needed or desired, and the resulting images (referred to here as final image frames or final view frames) can represent the final views of the scene. For instance, a 3D-to-2D warping can be used to warp the final views of the scene into 2D images. The frame rendering operation 240 can also present the rendered images to the user. For example, the frame rendering operation 240 can render the images into a form suitable for transmission to at least one display 160 and can initiate display of the rendered images, such as by providing the rendered images to one or more displays 160. In some cases, there may be a single display 160 on which the rendered images are presented for viewing by the user, such as where each eye of the user views a different portion of the display 160. In other cases, there may be separate displays 160 on which the rendered images are presented for viewing by the user, such as one display 160 for each of the user's eyes.

In some embodiments, object detection and object recognition can be performed in the attentional region 231 to provide the user with more information to understand the contents in the attentional region 231. Also, in some embodiments, after defining an attentional region 231, noise reduction and image enhancement can be used to make the attentional region 231 more clearer or readable. After improving image quality in this region 231, the lightness in the one or more transformed image frames 221 can be adjusted to allow the user to focus on the attentional region 231 as described above. In addition, in some embodiments, the entire transformed image frames can be set as default attentional regions while the user is not focusing on anything at that moment. In those cases, a camera frame capture can be simulated, making the lightness dark only towards the edges of the simulated camera frame.

Although FIG. 2 illustrates one example of a process 200 for dynamic attentional region generation and rendering, various changes may be made to FIG. 2. For example, various components or functions in FIG. 2 may be combined, further subdivided, replicated, omitted, or rearranged and additional components or functions may be added according to particular needs.

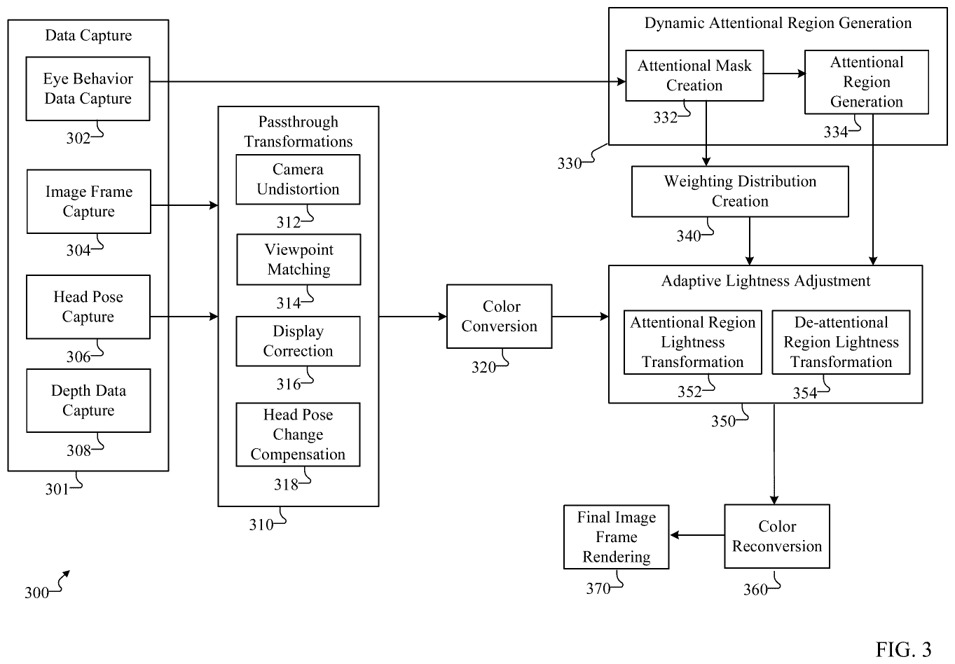

FIG. 3 illustrates another example process 300 for dynamic attentional region generation and rendering in accordance with this disclosure. For case of explanation, the process 300 shown in FIG. 3 is described as being performed using the electronic device 101 in the network configuration 100 shown in FIG. 1. However, the process 300 shown in FIG. 3 may be performed using any other suitable device(s) and in any other suitable system(s).

As shown in FIG. 3, the process 300 includes a data capture operation 301, a passthrough transformation operation 310, a color conversion operation 320, a dynamic attentional region generation operation 330, a weighting distribution creation operation 340, an adaptive lightness adjustment operation 350, a color reconversion operation 360, and a final image frame rendering operation 370. The data capture operation 301 generally operates to capture a color frame image and associated data. In this example, the data capture operation 301 includes an eye behavior data capture operation 302, an image frame capture operation 304, a head pose data capture operation 306, and a depth data capture operation 308.

The eye behavior data capture operation 302 generally operates to capture user eye information including a focus region and focal distance and may be the same as or similar to the eye behavior data capture operation 212 of FIG. 2. The image frame capture operation 304 generally operates to capture one or more image frames of a scene and may be the same as or similar to the image frame capture operation 214 of FIG. 2. The head pose data capture operation 306 generally operates to obtain information related to the pose of a user's head while the electronic device 101 is being used and may be the same as or similar to the head pose data capture operation 216 of FIG. 2. The depth data capture operation 308 generally operates to obtain depth data associated with each image frame. The depth data may be obtained from any suitable source(s), such as from one or more depth sensors like at least one time-of-flight (ToF) sensor, light detection and ranging (LiDAR) sensor, or stereo vision sensor. In some cases, for example, the depth data may include time measurements of light pulses returning to a ToF sensor, distorted light patterns, or RGB images from slightly different angles.

The passthrough transformation operation 310 generally operates to apply one or more passthrough transformations to the one or more captured image frames in order to generate one or more transformed image frames. The passthrough transformation operation 310 may be the same as or similar to the passthrough transformation operation 220 of FIG. 2. In this example, the passthrough transformation operation 310 includes a camera undistortion operation 312, a viewpoint matching operation 314, a display correction operation 316, and a head pose change compensation operation 318.

The camera undistortion operation 312 generally operates to correct lens distortions. This may include the processor 120 of the electronic device 101 undistorting captured image frames using respective intrinsic parameters of the imaging sensor(s) 180 used to capture the image frames. The intrinsic parameters generally describe how each imaging sensor 180 perceives objects and can include a focal length, a principal point, and distortion coefficients. The focal length may indicate the degree of the imaging sensor's telescopic strength (such as an amount of zooming). The principal point may indicate the center of the image on which the imaging sensor's optical points are focused. The distortion coefficients may indicate an extent of lens distortions (such as image warping caused by a lens of the imaging sensor). Since the processor 120 can learn the intrinsic parameters for each imaging sensor 180, the processor 120 can identify the extent of the lens distortions and correct for the associated image distortions, such as by moving pixels so that straight lines appear straight.

The viewpoint matching operation 314 generally operates to perform matching the sensor locations to the user viewpoints. This may include the processor 120 applying transformations to compensate for things like registration and parallax errors, which may be caused by factors like differences between the positions of the imaging sensor(s) 180 and the user's eyes. That is, captured image frames are captured by one or more imaging sensor(s) 180 at one or more locations, but rendered images are viewed by the user's eyes that are at different locations. The viewpoint matching operation 314 can perform one or more transformations to account for these different locations, giving the appearance that image frames are captured at the locations of the user's eyes.

The display correction operation 316 may include the processor 120 correcting for display lens distortions and chromatic aberrations. The display lens correction and the chromatic aberration correction can be used to compensate for distortions created in displayed images, such as geometric distortions and chromatic aberrations created by display lenses (which are lenses positioned between the user's eyes and one or more display panels forming the display(s) 160).

The head pose change compensation operation 318 generally operates to compensate for head pose changes that occur between image capture and image display. This may include the processor 120 applying a transformation to reproject each of the transformed image frames generated by the passthrough transformation operation 220 based on an expected head pose of the user (if necessary). For example, the processor 120 may obtain inputs from an IMU, a head pose tracking camera, or other position sensor(s) 180 of the electronic device 101 while image frames are being captured using the one or more imaging sensors 180. The processor 120 can use this information to estimate what the user's head pose will likely be when rendered images are actually displayed to the user. In many cases, for instance, image frames will be captured at one time and rendered images will be subsequently displayed to the user some amount of time later, and it is possible for the user to move his or her head during this intervening time period. The head pose change compensation can therefore be used to estimate, for each image frame, what the user's head pose will likely be when a rendered image based on that image frame will be displayed to the user. The head pose change compensation can also apply a translation, rotation, and/or other transformation to each transformed image frame, which can result in the generation of additional transformed image frames.

The color conversion operation 320 generally operates to convert each transformed image frame from a first image format that lacks luminance data to a second image format that includes luminance data. Any suitable image formats may be supported here. As particular examples, the image frames obtained by the image frame capture operation 304 may be in an RGB (red, green, blue) format, and the image frames may be converted into a YUV or YCbCr format or a hue, saturation, and value (HSV) format. The luminance data includes a luminance component or channel (Y or V) of the color converted format. In embodiments where the color conversion operation 320 is used, this conversion allows for the lightness adjustment of the transformed image frames for visibility enhancement.

The dynamic attentional region generation operation 330 generally operates to generate an attentional region in each of the one or more transformed image frames. In this example, the dynamic attentional region generation operation 330 includes an attentional mask creation operation 332 and an attentional region generation operation 334.

The attentional mask creation operation 332 generally operates to create an attentional mask using the user's eye gaze data, such as eye gaze vectors, eye vergence angle, focus point, and focal distance. This may include the processor 120 identifying the focus point and the focal distance between the focus point and the user's eyes and determining the size and shape of the attentional mask based on the focus point and the focal distance. In some embodiments, the attentional mask can be a binary or grayscale texture or depth-based data structure used to selectively control the visibility, application, or effects of certain portions of a transformed image frame. Here, the processor 120 may create an attentional mask to generate an attentional region that includes an object or portion of the user's interest. The processor 120 can create an attentional mask with different sizes and shapes (such as rectangular, circular, elliptical, or any other shapes) to fit the attentional region as appropriate without departing from the scope of this disclosure.

The attentional region generation operation 334 generally operates to generate an attentional region using the attentional mask. This may include the processor 120 defining the size, shape, and boundary of the attentional region based on the attentional mask. In some cases, the size, shape, and boundary of the attentional region can be the same as those of the attentional mask. The peripheral region disposed outside of the attentional region can be defined as a de-attentional region.

The weighting distribution creation operation 340 generally operates to create a weighting distribution for lightness adjustments using the attentional mask. In some cases, a weighting distribution may be a scalar function that assigns a weight to each point (pixel) in a transformed image frame based on a distance metric, which measures the distance between each point and a reference point (such as a center point of the image frame). One goal of the weighting distribution may be to ensure that the lightness does not change at the center point of the attentional region and gradually attenuates from the center point toward the edges of the de-attentional region. In some embodiments, this may include the processor 120 applying, for example, a Gaussian distribution to the weighting distribution D(x,y), which may be expressed as follows.

$$D ( x , y ) = a {e}^{- ( \frac{{( x - {x}_{c} )}^{2}}{2 {σ}_{x}^{2}} + \frac{{( y - {y}_{c} )}^{2}}{2 {σ}_{y}^{2}} )} \qquad ( 1 )$$

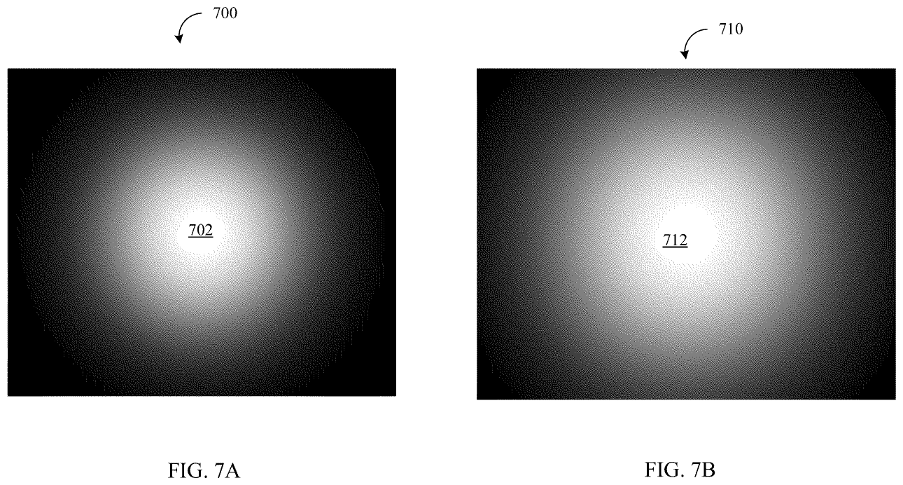

Here, a is a coefficient of the amplitude of the weighting function, p(x, y) is the image point of the attentional region, p(x_{c},y_{c}) is the center point of the attentional region, and (σₓ, σ_{y}) are standard deviations in x and y direction. One example of a weighting distribution using a Gaussian distribution is illustrated in FIG. 7A. In some cases, the weighting distribution can be radially symmetric, which can be expressed as follows.

$$σ = {σ}_{x} = {σ}_{y} \qquad ( 2 )$$

In other embodiments, the processor 120 may apply a cosine distribution to the weighting distribution B(d)∈[0, 1], which may be expressed as follows.

$$D ( x , y ) = cos {( c {d}_{r} ( x , y ) )}^{n} \qquad ( 3 )$$

$${d}_{r} ( x , y ) = \frac{d ( x , y )}{{R}_{max}} \qquad ( 4 )$$

$${R}_{max} = {c}_{r} {r}_{max} \qquad ( 5 )$$

$$d ( x , y ) = \sqrt{{( x - {x}_{c} )}^{2} + {( y - {y}_{c} )}^{2}} \qquad ( 6 )$$

Here, c is a coefficient for adjusting the distribution, and n is a power coefficient for adjusting the distribution. Also, rₘₐₓ is the maximum radius of the attentional region centered at p(x_{c},y_{c}), cᵣ is the radius coefficient, and d(x, y) is the distance between the current image point p(x, y) and the center point p(x_{c}, y_{c}) of the attentional region. One example of a weighting distribution using a cosine distribution is shown in FIG. 7B.

The adaptive lightness adjustment operation 350 generally operates to adjust lightness of each of the one or more transformed image frames. In this example, the adaptive lightness adjustment operation 350 includes an attentional region lightness transformation operation 352 and a de-attentional region lightness transformation operation 354. The attentional region lightness transformation operation 352 generally operates to adjust the lightness of the attentional region by applying the weighting distribution to the attentional region. This may include the processor 120 creating an attentional image Iₐ (x, y) by convoluting a source image with a lightness transformation kernel, which may be expressed as follows.

$${I}_{a} ( x , y ) = D ( x , y ) * I ( x , y ) \qquad ( 7 )$$

Here, D(x,y) is the kernel of the lightness transformation (which is a weighting distribution), and I(x,y) is the source image (such as a transformed image frame). The processor 120 can create different weighting distributions for different user's attentional regions. For example, the processor 120 can use a Gaussian distribution or cosine distribution as the weighting distribution D(x,y) as shown in Equations (1) and (3), respectively.

The processor 120 can adjust the lightness in the attentional region after applying the lightness transformation. In some cases, the resultant lightness L(x, y) of the user's view after the lightness transformation can be expressed as follows.

$$L ( x , y ) = D ( d ( x , y ) ) I ( x , y ) \qquad ( 8 )$$

Here, D(d(x, y)) is the weighting distribution for the lightness adjustment, d(x, y) is a distance function, and (x,y) is x and y coordinates of an image point in a transformed image frame.

The de-attentional region lightness transformation operation 354 generally operates to adjust lightness of the de-attentional region using the weighting distribution. This may include the processor 120 adjusting the lightness of the de-attentional region such that the de-attentional region has little or no lightness. In some cases, the de-attentional region has a small lightness and eventually becomes dark toward the frame boundary of the transformed image frame. Also, in some cases, the processor 120 may apply the same weighting function to the de-attentional region so as to continue the gradual attenuation of the lightness from the boundary of the attentional region towards the edges of the de-attentional region.

The color reconversion operation 360 generally operates to perform color reconversion after the adaptive lightness adjustment operation 350. This may include the processor 120 converting image data in the YUV, YCbCr, HSV, or other format with a luminance channel to another image format, such as one that lacks a luminance channel (like RGB format). In some embodiments, the color reconversion operation 360 may convert image frames back into their original image format. In some cases, this may be done to make the lightness-adjusted transformed image frames compatible for display and to provide improved user experience. This may include the processor 120 determining RGB data or other image data for every pixel based on the YUV, YCbCr, or HSV image frame to generate a new RGB or other image frame. For example, if an enhanced luminance channel Vis 0.7, the associated RGB value may be determined as R=V, G=0, and B=0. The processor 120 can scale the RGB value and repeat this conversion for every pixel in the visually-enhanced transformed image frame, creating a new RGB or other image frame with enhanced brightness/contrast and the original colors.

The final image frame rendering operation 370 generally operates to create final image frames of the converted transformed image frames and may be the same as or similar to the frame rendering operation 240 of FIG. 2. Among other things, the final image frames can include the processed attentional regions and de-attentional regions from the converted transformed image frames.

Although FIG. 3 illustrates another example of a process 300 for dynamic attentional region generation and rendering, various changes may be made to FIG. 3. For example, various components or functions in FIG. 3 may be combined, further subdivided, replicated, omitted, or rearranged and additional components or functions may be added according to particular needs.

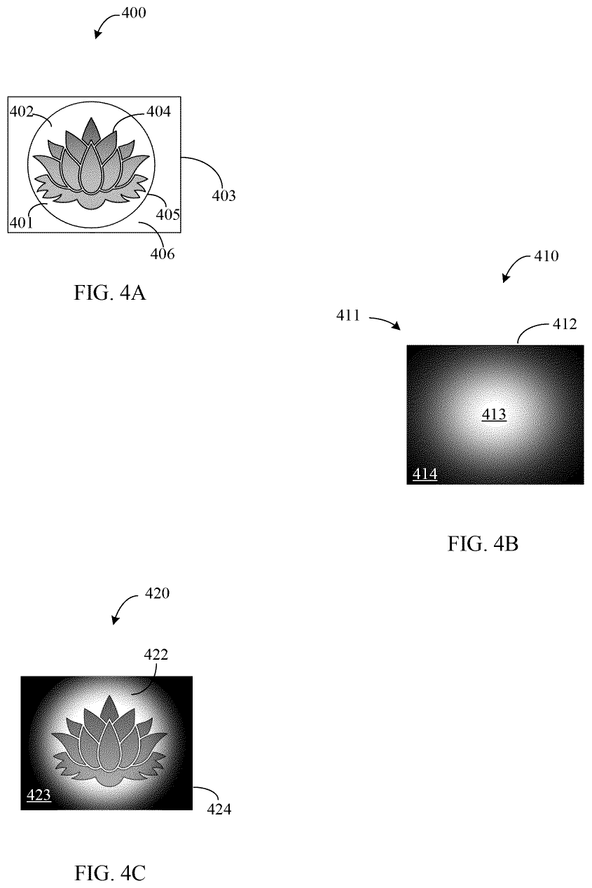

FIGS. 4A through 4C illustrate example functions in the process 300 of FIG. 3 in accordance with this disclosure. As shown in FIG. 4A, one operation associated with the process 300 is a dynamic generation 400 of an attentional region 401 using an attentional mask 402 within a transformed image frame 403. This may occur as part of the dynamic attentional region generation operation 330 of FIG. 3. Here, the user is focusing on an object 404, and the attentional region 401 is identified using the attentional mask 402. In this example, the attentional mask 402 has a circular shape having a size sufficient to encompass the object 404. The attentional region 401 and the attentional mask 402 may have the same size and shape. Upon identifying the attentional region 401, a de-attentional region 406 (such as a peripheral region disposed outside of the boundary 405 of the attentional region 401) can be identified.

As shown in FIG. 4B, another operation associated with the process 300 is a dynamic creation 410 of a weighting distribution 411 of lightness adjustment in a transformed image frame 412. This may occur as part of the dynamic attentional region generation operation 330 of FIG. 3. Here, the weighting distribution 411 is created for lightness adjustment for the transformed image frame to ensure that the lightness does not change at the center of the attentional region 413 but is attenuated gradually toward the edges of the de-attentional region 414. That is, the lightness peaks at the center point of the attentional region 413 and is gradually attenuated with a smooth transition at the boundary of the attentional region 413, where the de-attentional region 414 has little or no lightness.

As shown in FIG. 4C, yet another operation that may be associated with the process 300 is an adaptive lightness adjustment 420 for an attentional region 422 and a de-attentional region 423 of a transformed image frame 424. Here, using the weighting distribution, an attentional lightness transformation is applied to the attentional region 422 with an attentional mask and a de-attentional lightness transformation is applied to the de-attentional region 423. As shown in FIG. 4D, the attentional region 422 has a brighter lightness as compared to the de-attentional region 423, which has little or no lightness, thereby making it easier for the user to focus on the region of his or her interest.

Although FIGS. 4A through 4C illustrate examples of functions in the process 300 shown in FIG. 3, various changes may be made to FIGS. 4A through 4C. For example, the attentional mask 402 may have a non-circular shape depending on the eye behavior data and the object shape. As an example, the attentional region 401 may include the entire scene, rather than an object, if the user is not focusing on a particular point or object in the scene.

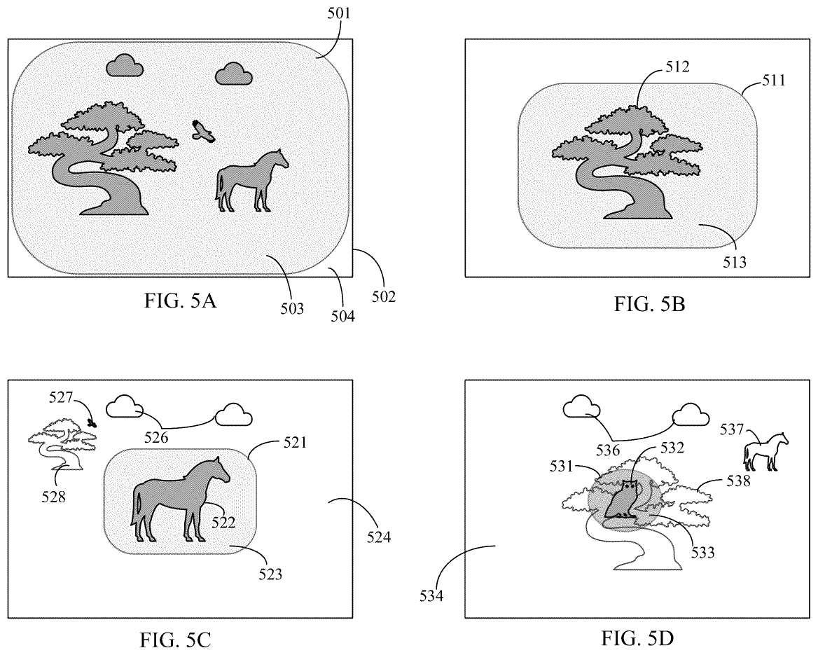

FIGS. 5A-D illustrate example attentional masks created in accordance with this disclosure. The attentional masks may, for example, be created via the attentional mask creation operation 332 of FIG. 3. For case of explanation, the attentional masks in FIGS. 5A-5D are described as being created using the electronic device 101 in the network configuration 100 shown in FIG. 1, where the electronic device 101 may implement the process 300 shown in FIG. 3. However, the attentional masks may be created using any other suitable device(s) and in any other suitable system(s) in accordance with this disclosure, and the attentional masks may be created using any other suitable process(es) designed in accordance with this disclosure.

As shown in FIG. 5A, an attentional mask 501 is created for the entirety of a transformed image frame 502. This is because the user is focusing on the entire transformed image frame 502 or is generally not focusing on any particular portion of a scene. The attentional mask 501 can be used for generating an attentional region 503 with camera lens field of view effects (vignetting), which falls off in brightness towards the edges and corners of the image in a de-attentional region 504. Here, the attentional mask 501 has a rectangular shape.

As shown in FIG. 5B, an attentional mask 511 is created to cover the objects in the user's view. Since there is only one object (a tree) 512 in the user's view, the attentional region 513 is generated to include the object 512 and allow the user to focus only on the object 512 in his or her view. Here, the attentional mask 511 has a rectangular shape.

As shown in FIG. 5C, an attentional mask 521 is created when the user is focusing on one object (a horse) 522 in the scene. The attentional mask 521 only covers the object 522 of the user's focus. Using the attentional mask 521, an attentional region 523 is generated to include only the object to allow the user to focus on the object 522 of user focus. A de-attentional region 524 includes the remaining objects 526-528 disposed outside of the attentional region 523. Here, the attentional mask 521 has a rectangular shape.

As shown in FIG. 5D, an attentional mask 531 is created when the user is focusing on one object (an owl) 532 within another object 538. In FIG. 5D, the attentional mask 531 has a circular shape to generate an attentional region 533 to allow the user to focus on the focused object 532 only. The remaining objects 536, 537 and portions of the overlapping object 538 not included the attentional region 533 are all disposed in a de-attentional region 534.

Although FIGS. 5A through 5D illustrate examples of attentional masks created using the process 300 shown in FIG. 3, various changes may be made to FIGS. 5A through 5D as appropriate without departing from the scope of this disclosure. For example, different attentional masks with different shapes (such as elliptical or other shapes) can be created according to the objects on which the user is focusing and the distances of the objects.

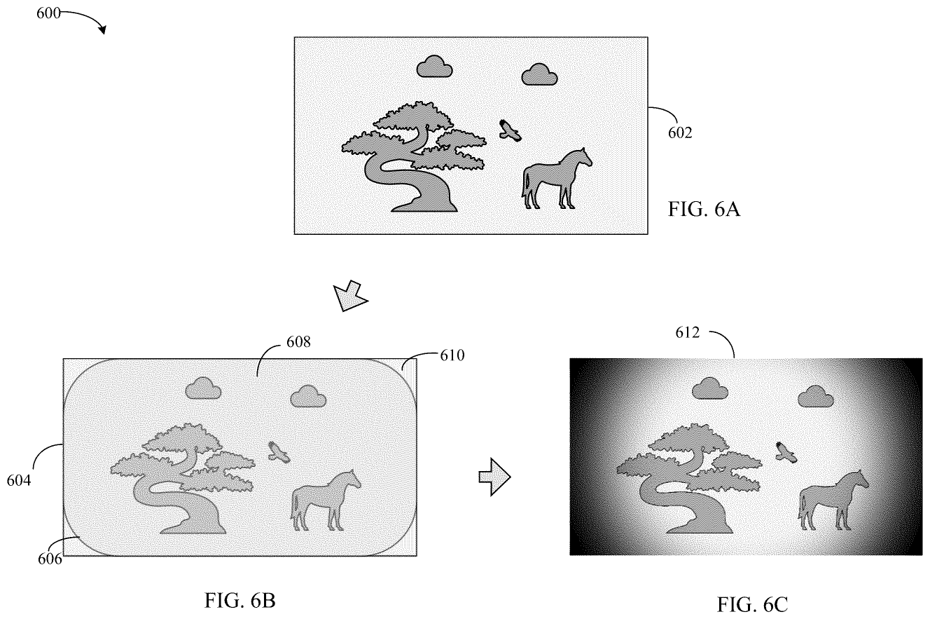

FIGS. 6A-6C illustrate an example technique 600 for adaptive lightness transformation in accordance with this disclosure. The technique 600 may, for example, be used as part of the adaptive lightness adjustment operation 350 of FIG. 3. For case of explanation, the technique 600 shown in FIGS. 6A-6C is described as being implemented using the electronic device 101 in the network configuration 100 shown in FIG. 1, where the electronic device 101 may implement the process 300 shown in FIG. 3. However, the technique 600 may be implemented using any other suitable device(s) and in any other suitable system(s), and the technique 600 may be used to implement any other suitable process(es) designed in accordance with this disclosure.

FIG. 6A shows an original image frame 602 capturing a scene including various objects, such as a tree, a horse, a bird, and clouds. The captured image frame undergoes passthrough transformations to generate a transformed image frame 604. The color format of the transformed image frame 604 may optionally be converted to extract luminance data. In this example, the user is focusing on the whole of the original image frame 602. Hence, as shown in FIG. 6B, an attentional mask 606 is created to include all of the objects in the scene. Using the attentional mask 606, an attentional region 608 and a de-attentional region 610 are generated.

A weighting distribution can be created using the attentional mask 606 and applied to the transformed image frame 604 to adjust the lightness thereof. The weighting distribution is a kernel of lightness transformation, and the transformed image frame 604 is convolved with the kernel to generate a modified image frame 612. Note that any suitable distribution algorithm may be used here, such as a Gaussian distribution or a cosine distribution.

The attentional region and the de-attentional region undergo an attentional lightness transformation and the de-attentional region transformation using the selected distribution algorithm. As shown in FIG. 6C, the lightness peaks at the center of the modified image frame 612 and is attenuated gradually towards the edges of the de-attentional region 610, with a smooth transition from the attentional region 608 to the de-attentional region 610. As shown in FIG. 6C, all of the objects in the modified image frame 612 are in the lightness adjusted attentional region in accordance with the user focus. After the adaptive lightness transformations have been applied, a final image frame is generated for rendering.

Although FIGS. 6A through 6C illustrate one example of a technique 600 for adaptive lightness transformation using the process 300 shown in FIG. 3, various changes may be made to FIGS. 6A through 6C as appropriate without departing from the scope of this disclosure. For example, while the attentional mask 606 has a rectangular shape, it can have a different shape, such as an ellipse, a circle, or any other appropriate shape. Also, the attentional region 608 may include a specific object or portion of the scene as the user shifts his or her focus, thereby dynamically adapting to the instantaneous user focus.

FIGS. 7A-7B illustrate example weighting distributions 700,710 of lightness adjustments in accordance with this disclosure. The weighting distributions 700,710 may, for example, be used as part of the weighting distribution creation operation 340 of FIG. 3. For case of explanation, the weighting distributions 700,710 shown in FIGS. 7A-7B are described as being implemented using the electronic device 101 in the network configuration 100 shown in FIG. 1, where the electronic device 101 may implement the process 300 shown in FIG. 3. However, the weighting distributions 700,710 may be implemented using any other suitable device(s) and in any other suitable system(s), and the weighting distributions 700,710 may be used to implement any other suitable process(es) designed in accordance with this disclosure.

As shown in FIGS. 7A and 7B, different weighting distributions can be applied for different attentional regions. Different weighting distributions result in different the lightness adjustments in the image frame. In the example of FIG. 7A, a weighting distribution 700 is created using a Gaussian distribution (normal distribution) in accordance with Equations (1) and (2). The weighting distribution 700 produces a smooth bell-shaped weight distribution centered at the center point of the attentional region 702. That is, this weighting distribution 700 creates a smooth radially-symmetric falloff in lightness with the brightest point at the center and intensity decreasing exponentially towards a boundary of the attentional region 702.

In the example of FIG. 7B, a weighting distribution 710 is created using a cosine distribution in accordance with Equation (3). In the cosine distribution, the intensity varies with the cosine of the angle between a light source and surface normal. Thus, the brightness is the highest when the surface is perpendicular to the light source and zero when the surface is parallel to the light source. In this example, a radially-defined cosine distribution 710 with parameters cᵣ=1.0, c=0.8, and n=10 is used. Thus, the intensity is highest at the center of the attentional region 712 and decreases as the distance from the center increases.

Different distribution algorithms yield different effects. With the cosine distribution 710, the lightness decreases more linearly as compared to the exponential decay of the Gaussian distribution 700. For example, with the cosine distribution 710, the lightness is spread more evenly across a wider area as compared to the concentrated peak of the Gaussian distribution 700. However, this creates a less focused lightness effect and reduces visual emphasis on a single point. Different distribution algorithms can be selected based on the user preferences or application types.

Although FIGS. 7A and 7B illustrate examples of weighting distributions 700,710 of lightness adjustments using the Gaussian and cosine distributions, various changes may be made to FIGS. 7A-7B. For example, any other distribution algorithms can be applied for the weighting distribution for lightness adjustments as appropriate without departing from the scope of this disclosure. As a particular example, a Lorentzian (Cauchy) distribution may be used to produce a bright central peak with extended gradual falloff, generating a glowing effect with more pronounced tails than the Gaussian distribution.

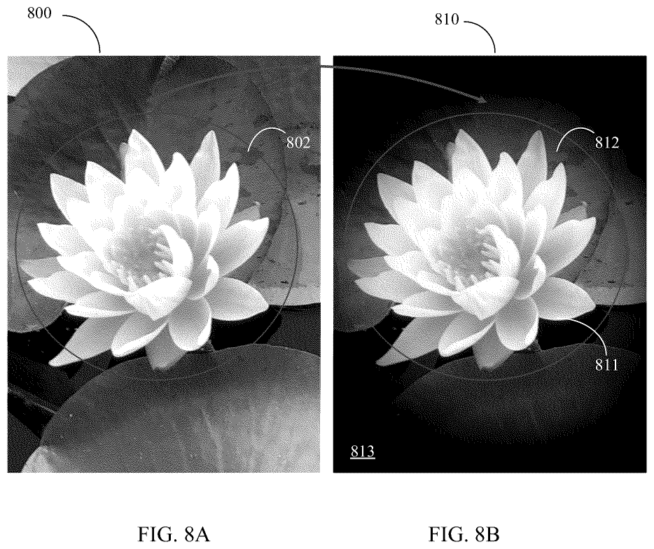

FIGS. 8A-8B illustrate example results obtainable using dynamic attentional region generation and rendering in accordance with this disclosure. More specifically, FIG. 8A illustrates an example output image 800 generated without using dynamic attentional region generation. As can be seen here, the output image 800 appears to have a uniform brightness in the image as a whole, thereby making it difficult for the user to focus on the area 802 of his or her interest. Among other things, this can cause discomfort to a user viewing the output image 800 or otherwise reduce the user's experience.

FIG. 8B illustrates an example output image 810 generated using the techniques described above. As can be seen here, the resulting image 810 accentuates an object (the flower) 811 of the user focus from the background. Among other reasons, this is because the electronic device 101 is able to perform dynamic attentional region generation on-the-fly to generate an attentional region 812 having a lightness higher than the background (a de-attentional region 813), making it easier for the user to focus on the attentional region 812 while ignoring the de-attentional region 813. This can result in significant improvements in the user's experience.

Although FIGS. 8A-8B illustrate one example of results obtainable using dynamic attentional region generation and rendering, various changes may be made to FIGS. 8A-8B. For example, FIGS. 8A-8B are merely meant to illustrate one example of a type of benefit that might be obtained using the techniques of this disclosure. The specific results that are obtained in any given situation can vary based on the circumstances and based on the specific implementation of the techniques described in this disclosure.

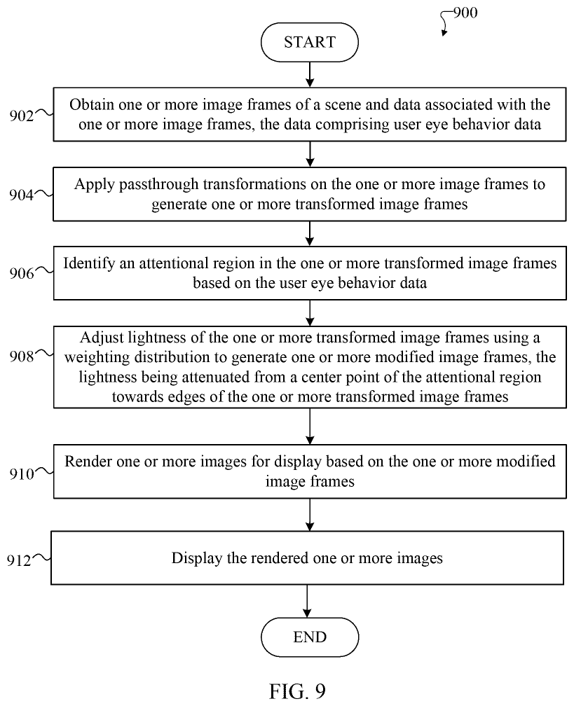

FIG. 9 illustrates an example method 900 for dynamic attentional region generation and rendering in accordance with this disclosure. For ease of explanation, the method 900 shown in FIG. 9 is described as being performed using the electronic device 101 in the network configuration 100 shown in FIG. 1, where the electronic device 101 may implement the process 300 shown in FIG. 3. However, the method 900 may be performed using any other suitable device(s) and in any other suitable system(s), and the method 900 may be implemented using any other suitable process(es) or architecture(s) designed in accordance with this disclosure.

As shown in FIG. 9, at step 902, one or more image frames of a scene and data associated with the one or more image frames are obtained. This may include, for example, the processor 120 of the electronic device 101 obtaining one or more image frames and data associated with the one or more image frames using a plurality of sensors 180 of the electronic device 101. The data associated with the one or more image frames can include user eye behavior data. At step 904, passthrough transformations on the one or more image frames are applied to generate one or more transformed image frames. This may include, for example, the processor 120 of the electronic device 101 applying one or more transformations for camera undistortion, viewpoint matching, display correction, and/or head pose change compensation.

At step 906, an attentional region is identified in the one or more transformed image frames based on the user eye behavior data. This may include, for example, the processor 120 of the electronic device 101 identifying an element of a user focus in the one or more transformed image frames, where the element includes an object, an image portion, or an area of the user focus. This may also include the processor 120 of the electronic device 101 identifying a focus point and a corresponding focal distance based on the element and creating an attentional mask using the focus point and the corresponding focal distance, where the attentional mask encompasses the element. This may further include the processor 120 of the electronic device 101 generating the attentional region using the attentional mask, where the attentional region includes the element. A de-attentional region disposed outside of a boundary of the attentional region may also be identified. The attentional mask may have a shape including one of a rectangle, a circle, or an ellipse based on the element of the user focus and the focal distance.

At step 908, lightness of the one or more transformed image frames is adjusted using a weighting distribution to generate one or more modified image frames, where the lightness is attenuated from a center point of the attentional region towards edges of the one or more transformed image frames. This may include, for example, the processor 120 of the electronic device 101 converting a color format of the one or more transformed image frames to extract lightness data and creating the weighting distribution using the attentional mask. This may also include the processor 120 of the electronic device 101 applying the weighting distribution to the attentional region and the de-attentional region to adjust the lightness. The lightness of the attentional region may be unchanged at the center point and attenuated towards edges of the de-attentional region such that the de-attentional region has little or no lightness at the edges. In some cases, the weighting distribution may include a Gaussian distribution or a cosine distribution. Also, in some cases, the weighting distribution may be dynamically adaptive to a user focus. In some example, the lightness of the one or more transformed image frames may be adjusted by applying an attentional lightness transformation on the attentional region using a distribution algorithm for the weighting distribution and applying a de-attentional lightness transformation on a de-attentional region disposed outside of a boundary of the attentional region using the distribution algorithm.

At step 910, one or more images are rendered based on the one or more modified image frames for display. At step 912, displaying the rendered one or more images is initiated. This may include, for example, the processor 120 of the electronic device 101 rendering the images based on the transformed image frames and displaying the rendered images on at least one display 160 of the electronic device 101. In some embodiments, visual enhancement on the attentional region may be applied before or during the rendering. In some cases, the visual enhancement may include noise reduction and image enhancement.

Although FIG. 9 illustrates one example of a method 900 for dynamic attentional region generation and rendering, various changes may be made to FIG. 9. For example, while shown as a series of steps, various steps in FIG. 9 may overlap, occur in parallel, occur in a different order, or occur any number of times (including zero times).

It should be noted that the functions shown in or described with respect to FIGS. 2 through 9 can be implemented in an electronic device 101, 102, 104, server 106, or other device(s) in any suitable manner. For example, in some embodiments, at least some of the functions shown in or described with respect to FIGS. 2 through 9 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 9 can be implemented or supported using dedicated hardware components. In general, the functions shown in or described with respect to FIGS. 2 through 9 can be performed using any suitable hardware or any suitable combination of hardware and software/firmware instructions. Also, the functions shown in or described with respect to FIGS. 2 through 9 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
obtaining, using a plurality of sensors of an electronic device, one or more image frames of a scene and data associated with the one or more image frames, the data comprising user eye behavior data;
applying, using at least one processing device of the electronic device, passthrough transformations on the one or more image frames to generate one or more transformed image frames;
identifying, using the at least one processing device, an attentional region in the one or more transformed image frames based on the user eye behavior data;
adjusting, using the at least one processing device, lightness of the one or more transformed image frames using a weighting distribution to generate one or more modified image frames, the lightness being attenuated from a center point of the attentional region towards edges of the one or more transformed image frames; and
rendering, using the at least one processing device, one or more images for display based on the one or more modified image frames.

2. The method of claim 1, wherein identifying the attentional region comprises:
identifying an element of a user focus in the one or more transformed image frames, the element comprising an object, an image portion, or an area of the user focus;
identifying a focus point and a corresponding focal distance based on the element;
creating an attentional mask using the focus point and the corresponding focal distance, the attentional mask encompassing the element; and
generating the attentional region using the attentional mask, the attentional region including the element; and
wherein the method further comprises identifying a de-attentional region disposed outside of a boundary of the attentional region.

3. The method of claim 2, wherein adjusting the lightness comprises:
converting a color format of the one or more transformed image frames to extract lightness data;
creating the weighting distribution using the attentional mask; and
applying the weighting distribution to the attentional region and the de-attentional region to adjust the lightness, the lightness at the center point of the attentional region being unchanged and attenuated towards edges of the de-attentional region such that the de-attentional region has little or no lightness at the edges.

4. The method of claim 2, wherein the attentional mask has a shape comprising one of a rectangle, a circle, or an ellipse based on the element of the user focus and the focal distance.

5. The method of claim 1, wherein adjusting the lightness comprises:
applying an attentional lightness transformation on the attentional region using a distribution algorithm for the weighting distribution; and
applying a de-attentional lightness transformation on a de-attentional region disposed outside of a boundary of the attentional region using the distribution algorithm.

6. The method of claim 1, wherein the weighting distribution comprises a Gaussian distribution or a cosine distribution.

7. The method of claim 1, wherein the weighting distribution is dynamically adaptive to a user focus.

8. The method of claim 1, further comprising:
applying visual enhancement on the attentional region, the visual enhancement including noise reduction and image enhancement.

9. An apparatus comprising:
a plurality of sensors configured to obtain one or more image frames of a scene and data associated with the one or more image frames, the data comprising user eye behavior data; and
at least one processing device configured to:
apply passthrough transformations on the one or more image frames to generate one or more transformed image frames;
identify an attentional region in the one or more transformed image frames based on the user eye behavior data;
adjust lightness of the one or more transformed image frames using a weighting distribution to generate one or more modified image frames, the lightness being attenuated from a center point of the attentional region towards edges of the one or more transformed image frames; and
render one or more images for display based on the one or more modified image frames.

10. The apparatus of claim 9, wherein, to identify the attentional region, the at least one processing device is configured to:
identify an element of a user focus in the one or more transformed image frames, the element comprising an object, an image portion, or an area of the user focus;
identify a focus point and a corresponding focal distance based on the element;
create an attentional mask using the focus point and the corresponding focal distance, the attentional mask encompassing the element; and
generate the attentional region using the attentional mask, the attentional region including the element; and
wherein the at least one processing device is further configured to identify a de-attentional region disposed outside of a boundary of the attentional region.

11. The apparatus of claim 10, wherein, to adjust the lightness, the at least one processing device is configured to:
convert a color format of the one or more transformed image frames to extract lightness data; and
apply the weighting distribution to the attentional region and the de-attentional region to adjust the lightness, the lightness at the center point of the attentional region being unchanged and attenuated towards edges of the de-attentional region such that the de-attentional region has little or no lightness at the edges.

12. The apparatus of claim 10, wherein the attentional mask has a shape comprising one of a rectangle, a circle, or an ellipse based on the element of the user focus and the focal distance.

13. The apparatus of claim 9, wherein, to adjust the lightness, the at least one processing device is configured to:
apply an attentional lightness transformation on the attentional region using a distribution algorithm for the weighting distribution; and
apply a de-attentional lightness transformation on a de-attentional region disposed outside of a boundary of the attentional region using the distribution algorithm.

14. The apparatus of claim 9, wherein the at least one processing device is configured to dynamically adapt the weighting distribution to a user focus.

15. The apparatus of claim 9, wherein the at least one processing device is further configured to apply visual enhancement on the attentional region, the visual enhancement including noise reduction and image enhancement.

16. A non-transitory machine readable medium containing instructions that when executed cause at least one processor of an electronic device to:
obtain one or more image frames of a scene and data associated with the one or more image frames, the data comprising user eye behavior data;
apply passthrough transformations on the one or more image frames to generate one or more transformed image frames;
identify an attentional region in the one or more transformed image frames based on the user eye behavior data;
adjust lightness of the one or more transformed image frames using a weighting distribution to generate one or more modified image frames, the lightness being attenuated from a center point of the attentional region towards edges of the one or more transformed image frames; and
render one or more images for display based on the one or more modified image frames.

17. The non-transitory machine readable medium of claim 16, wherein the instructions that when executed cause the at least one processor to identify the attentional region comprise instructions that when executed cause the at least one processor to:
identify an element of a user focus in the one or more transformed image frames, the element comprising an object, an image portion, or an area of the user focus;
identify a focus point and a corresponding focal distance based on the element;
create an attentional mask using the focus point and the corresponding focal distance, the attentional mask encompassing the element; and
generate the attentional region using the attentional mask, the attentional region including the element; and
wherein the non-transitory machine readable medium furthers contains instructions that when executed cause the at least one processor to identify a de-attentional region disposed outside of a boundary of the attentional region.

18. The non-transitory machine readable medium of claim 17, wherein the instructions that when executed cause the at least one processor to adjust the lightness comprise instructions that when executed cause the at least one processor to:
convert a color format of the one or more transformed image frames to extract lightness data; and
apply the weighting distribution to the attentional region and the de-attentional region to adjust the lightness, the lightness at the center point of the attentional region being unchanged and attenuated towards edges of the de-attentional region such that the de-attentional region has little or no lightness at the edges.

19. The non-transitory machine readable medium of claim 17, wherein the attentional mask has a shape comprising one of a rectangle, a circle, or an ellipse based on the element of the user focus and the focal distance.

20. The non-transitory machine readable medium of claim 16, wherein the instructions that when executed cause the at least one processor to adjust the lightness comprise instructions that when executed cause the at least one processor to:
apply an attentional lightness transformation on the attentional region using a distribution algorithm for the weighting distribution; and
apply a de-attentional lightness transformation on a de-attentional region disposed outside of a boundary of the attentional region using the distribution algorithm.
